(19) United States
(12) Patent Application Publication
(10) Pub. No.: US 2015/0272135 A1
(43) Pub. Date: Oct. 1, 2015

(54) Automatic Bread Maker Assembly

(71) Applicant: Tsann Kuen Zhangzhou, Fujian (CN)

(72) Inventors: Hei-Wang Lee, Fujian (CN); Zhong-Hua Zhang, Fujian (CN); Xiao-Sen Sun, Fujian (CN)

(21) Appl. No.: 14/336,380

(22) Filed: Jul. 21, 2014

(30) Foreign Application Priority Data
Apr. 1, 2014 (CN) 201410128274.9

(51) Int. Cl. A21B 7/00; A21B 1/52

(52) U.S. Cl. CPC A21B 7/005; A21B 1/52

(57) ABSTRACT

An automatic bread maker assembly includes an automatic bread maker and an ingredient storage unit. The ingredient storage unit includes a container and an electrical resistance tag attached to the container. When the ingredient storage unit is disposed in a receiving space of the automatic bread maker, an electrode unit of the automatic bread maker contacts the electrical resistance tag and provides the electrical resistance value of the electrical resistance tag to a baking mechanism. The baking mechanism is configured to make bread automatically using the bread ingredients stored in the container with a particular bread-making process that is determined according to the electrical resistance value.

### CROSS-REFERENCE TO RELATED APPLICATION

This application claims priority of Chinese Application No. 201410128274.9, filed on Apr. 1, 2014.

### BACKGROUND OF THE INVENTION

1. Field of the Invention

The invention relates to an automatic bread maker assembly, and more particularly to an automatic bread maker assembly including an automatic bread maker and an ingredient storage unit that enables the automatic bread maker to make bread automatically using bread ingredients in the ingredient storage unit.

2. Description of the Related Art

In general, a conventional automatic bread maker includes an ingredient container and a heater connected to the ingredient container. In use, according to user selection of a bread-making process, the ingredient container is capable of mixing or kneading bread ingredients and of fermenting a bread dough therein. The heater is for heating the bread dough in the ingredient container. However, a user has to accurately weigh several ingredients of a desired type of bread, and then appropriately select a particular bread-making process. As a result, such an automatic bread maker may be inconvenient for making different types of bread.

In order to improve convenience of bread making, another conventional automatic bread maker 5 (see FIG. 9) is configured to make bread with an ingredient bag 6. The ingredient bag 6 is filled with several ingredients of a particular type of bread, and has a bar code 61 that is associated with information of the ingredients. When the ingredient bag 6 is movably disposed in the automatic bread maker 5 and is gripped by a spindle 51, the spindle 51 rolls up the ingredient bag 6 such that a bar code reader 52 of the automatic bread maker 5 contacts and reads the bar code 61. As a result, the automatic bread maker 5 is capable of obtaining the information of the ingredients, and is configured to automatically select a bread-making process to make bread using the ingredients in the ingredient bag 6. However, since the ingredient bag 6 is deformable and the bar code 61 is rolled when the bar code reader 52 reads the bar code 61, the bar code reader 52 may incorrectly read the bar code 61 such that the automatic bread maker 5 may select an inappropriate bread-making process.

### SUMMARY OF THE INVENTION

Therefore, an object of the present invention is to provide an automatic bread maker assembly that may alleviate the aforesaid drawback of the prior art.

According to one aspect of the present invention, an automatic bread maker assembly includes an automatic bread maker and an ingredient storage unit.

The automatic bread maker includes a casing having a receiving space, a baking mechanism disposed in the receiving space, and an electrode unit mounted on the casing and electrically coupled to the baking mechanism.

The ingredient storage unit is removably disposed in the receiving space. The ingredient storage unit includes a container and an electrical resistance tag attached to the container. The container has a bread ingredient space for accommodating bread ingredients. The electrical resistance tag has an electrical resistance value that is associated with information of the bread ingredients stored in the container.

When the ingredient storage unit is disposed in the receiving space, the electrode unit contacts the electrical resistance tag and provides the electrical resistance value of the electrical resistance tag to the making mechanism, and the baking mechanism is configured to make bread automatically using the bread ingredients stored in the container with a particular bread-making process that is determined according to the electrical resistance value received from the electrode unit.

According to another aspect of the present invention, an ingredient storage unit is for storing bread ingredients therein and is adapted to be used in an automatic bread maker that is configured to make bread automatically using the bread ingredients and that includes an electrode unit. The ingredient storage unit includes a container and an electrical resistance tag attached to the container.

The container has a bread-ingredient space for accommodating the bread ingredients.

The electrical resistance tag has an electrical resistance value that is associated with information of the bread ingredients stored in the container.

When the ingredient storage unit is disposed in the automatic bread maker, the electrical resistance tag contacts the electrode unit so as to allow the electrode unit to provide the electrical resistance value of the electrical resistance tag to the automatic bread maker, thereby enabling the automatic bread maker to make bread using the bread ingredients stored in the container with a particular bread-making process that is determined according to the electrical resistance value provided by the electrode unit.

According to still another aspect of the present invention, an automatic bread maker is configured to make bread automatically using bread ingredients stored in an ingredient storage unit. The ingredient storage unit includes an electrical resistance tag having an electrical resistance value associated with information of the bread ingredients. The automatic bread maker includes a casing having a receiving space, a baking mechanism disposed in the receiving space, and an electrode unit mounted on the casing and electrically coupled to the baking mechanism.

When the ingredient storage unit is disposed in the receiving space, the electrode unit contacts the electrical resistance tag and provides the electrical resistance value of the electrical resistance tag to the baking mechanism, and the baking mechanism is configured to make bread automatically using the bread ingredients with a particular bread-making process that is determined according to the electrical resistance value received from the electrode unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of an automatic bread maker assembly according to the present invention;

FIG. 2 is a fragmentary partly-sectional view of the preferred embodiment;

FIG. 3 is a schematic sectional view of a lid body of the preferred embodiment taken along line of FIG. 2;

FIG. 4 is an exploded perspective view illustrating an ingredient storage unit of the preferred embodiment;

FIG. 5 is a fragmentary sectional view of a container of the ingredient storage unit of the preferred embodiment;

FIG. 6 is a schematic view illustrating stacked containers of the preferred embodiment;

FIG. 7 is a flow chart of bread-making processes of the preferred embodiment;

FIG. 8 is a block diagram of a baking mechanism of the preferred embodiment; and

FIG. 9 is a sectional view of a conventional automatic bread maker.

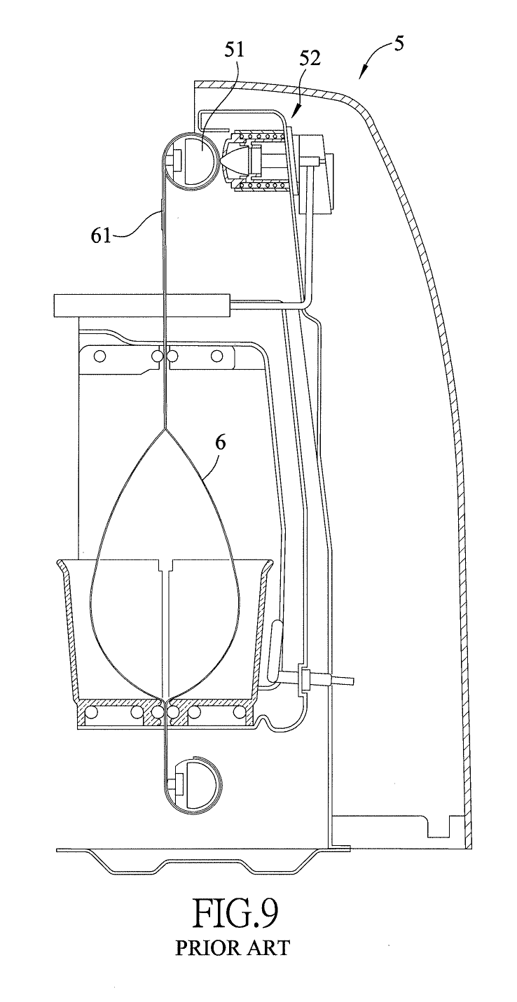

### DETAILED DESCRIPTION OF THE PREFERRED EMBODIMENT

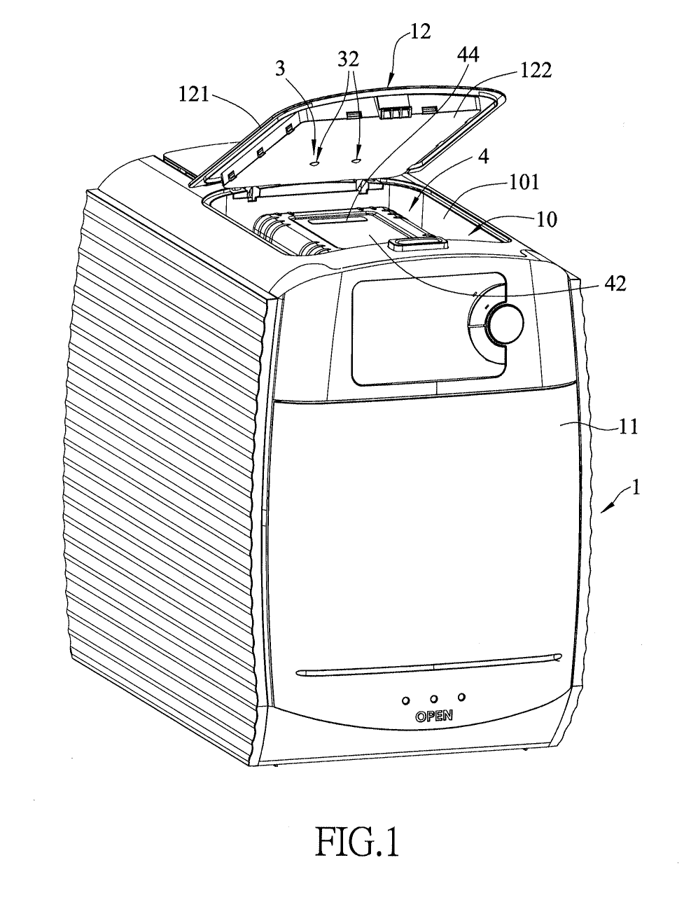

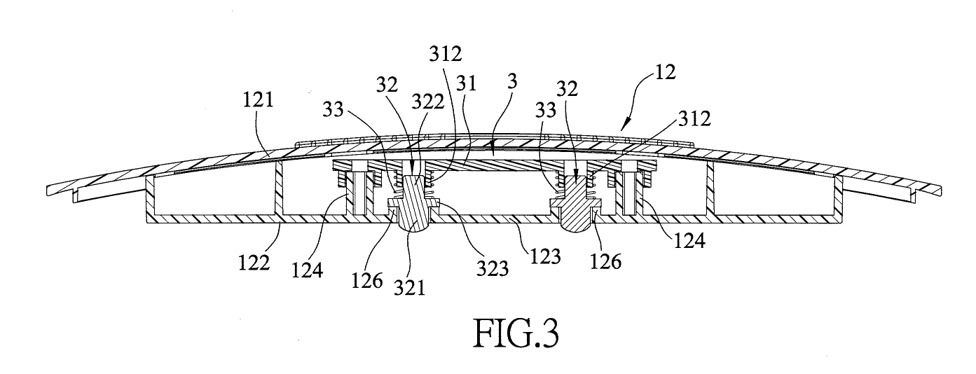

Referring to FIGS. 1 to 3, the preferred embodiment of an automatic bread maker assembly according to the present invention is shown to include an automatic bread maker and an ingredient storage unit 4.

The automatic bread maker includes a casing 1 having a receiving space 10, a baking mechanism 2 disposed in the receiving space 10, and an electrode unit 3 mounted on the casing 1.

In this preferred embodiment, the casing 1 includes a casing body 11 defining the receiving space 10 with an opening 101, and a lid body 12 movably connected to the casing body 11 for removably covering the opening 101 of the receiving space 10. The lid body 12 has an outer wall 121, and an inner wall 122 that is connected to the outer wall 121 and that faces the opening 101 of the receiving space 10 when the lid body 12 covers the opening 101. The inner wall 122 has a flat portion 123, two connecting portions 124 extending from the flat portion 123 toward the outer wall 121, and two spaced-apart tube portions 126 extending from the flat portion 123 and disposed between the connecting portions 124.

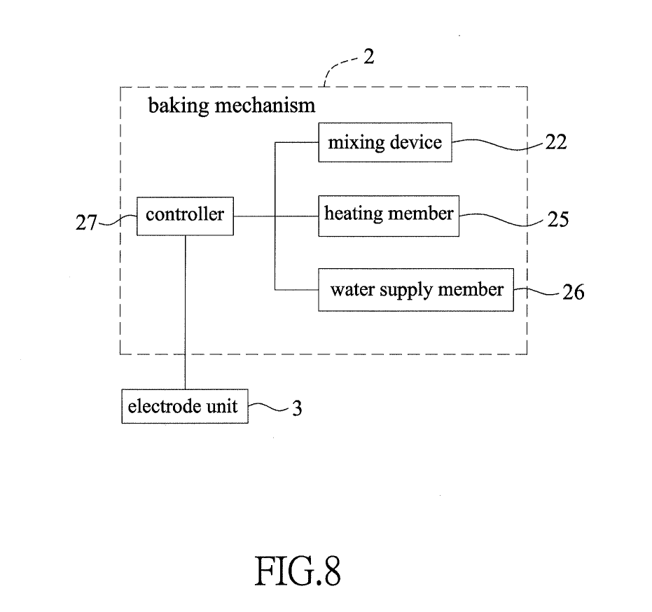

The baking mechanism 2 includes a baking container 21, a mixing device 22, a supporting frame 23, a penetrating member 24, a heating member 25, a water supply member 26, and a controller 27 (see FIG. 8). The baking container 21 is disposed in the receiving space 10 for receiving bread ingredients from the ingredient storage unit 4. The mixing device 22 is provided in the baking container 21 for mixing and kneading the bread ingredients. The supporting frame 23 is disposed in the receiving space 10 in proximity to the opening 101 over the baking container 21. The penetrating member 24 is disposed proximately under the supporting frame 23. The heating member 25 is mounted around the baking container 21. The water supply member 26 is disposed in the receiving space 10, and is configured to supply water into the baking container 21. The controller 27 is electrically coupled to the mixing device 22, the heating member 25 and the water supply member 26. Since the feature of this invention does not reside in the specific configurations of the mixing device 22, the penetrating member 24, the heating member 25, the water supply member 26 and the controller 27, which may be readily appreciated by those skilled in the art, details of the same are omitted herein for the sake of brevity.

The electrode unit 3 is mounted between the outer wall 121 and the inner wall 122, and is electrically coupled to the baking mechanism 2. In this preferred embodiment, the electrode unit 3 includes a connection plate 31 connected to the connecting portions 124, two electrode rods 32 that are disposed on the casing 1, that are electrically coupled to the controller 27 (see FIG. 8) of the baking mechanism 2 and that are spaced apart from each other, and two resilient members 33 that resiliently bias the electrode rods 32, respectively. In this preferred embodiment, the connection plate 31 is secured to the connecting portions 124 by a plurality of screws, and has two spaced-apart hollow guiding portions 312 that extend from the connection plate 31 toward the inner wall 122 and that are respectively aligned with the tube portions 126. Each electrode rod 32 has a rod portion 322 that is movably disposed in a respective one of the guiding portions 312, a ring portion 323 that extends radially from one end of the rod portion 322 and that movably abuts against a respective one of the tube portions 126, and a contact portion 321 that extends from the end of the rod portion 322 and that movably extends through the respective one of the tube portions 126. Each of the resilient members 33 is disposed around the rod portion 322 and between the respective one of the guiding portions 312 and the ring portion 323. When the resilient members 33 are not subjected to external forces, the contact portions 321 of the electrode rods 32 respectively extend out of the flat portion 123 of the inner wall 122.

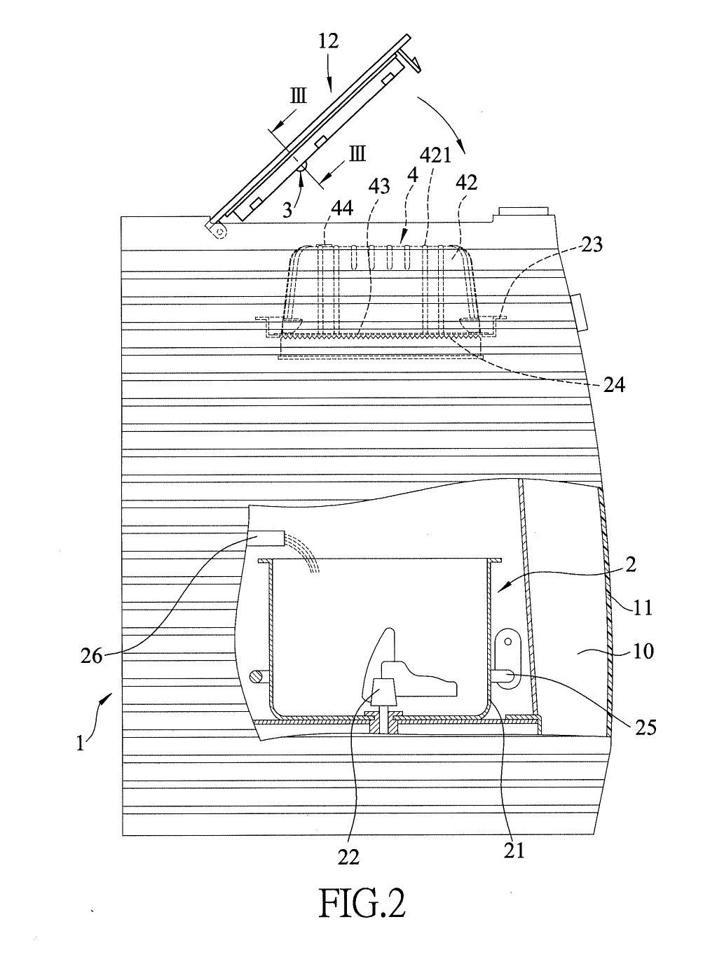

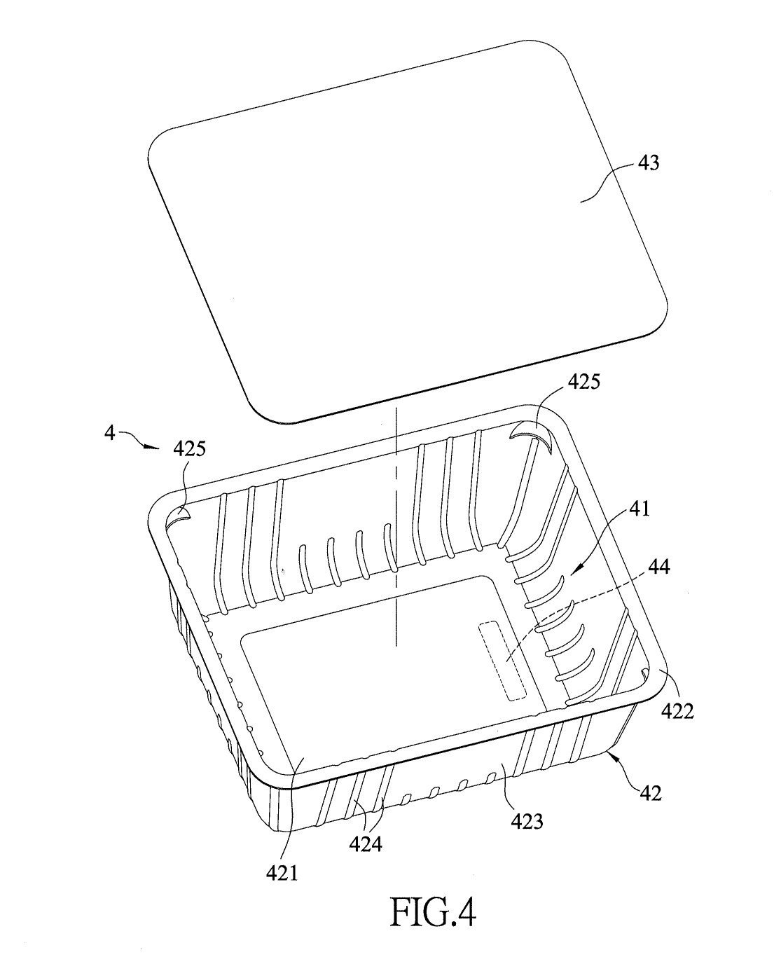

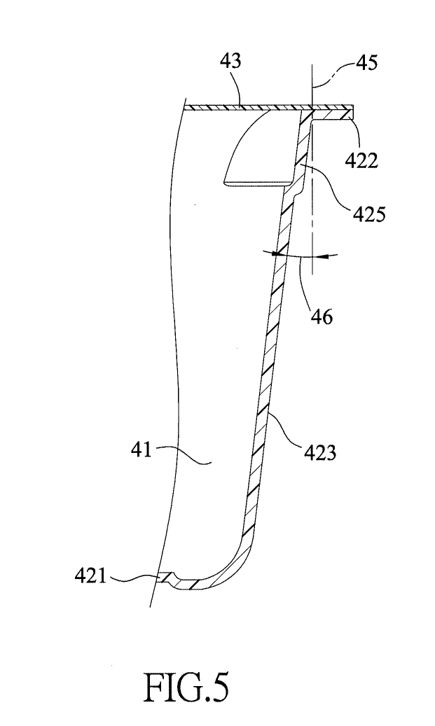

With reference to FIGS. 2, 4 and 5, the ingredient storage unit 4 is removably disposed in the receiving space 10. In this preferred embodiment, the ingredient storage unit 4 includes a container 42 that has a bread ingredient space 41 for accommodating the bread ingredients, a seal film 43 that seals the container 42, and an electrical resistance tag 44 that is attached to the container 42.

The container 42 has a fixed shape. Preferably, a thickness of the container 42 ranges from 0.8 millimeter to 1.5 millimeters. In this preferred embodiment, the container 42 includes a plate portion 421, and a surrounding wall 423 extending inclinedly and outwardly from the plate portion 421 with respect to the bread ingredient space 41. Preferably, the container 42 further includes an edge portion 422 that is connected to the surrounding wall 423, that extends around the surrounding wall 423 and that is opposite to the plate portion 421. The edge portion 422 is disposed on the supporting frame 23, such that the supporting frame 23 supports the container 42. In addition, the container 42 has a shape substantially of a frustum, and further includes a plurality of reinforcement ribs 424 and a plurality of reinforcement parts 425. The reinforcement ribs 424 are disposed on the surrounding wall 423, and extend from the plate portion 421 to the edge portion 422. The reinforcement parts 425 are depressed respectively from inside of corners of the surrounding wall 423, are proximate to the edge portion 422, and protrude outwardly and respectively from outside of the corners of the surrounding wall 423. In order to facilitate the bread ingredients leaving from the bread ingredient space 41, an angle 46 is preferable to be formed between the surrounding wall 423 and a normal line 45 perpendicular to an imaginary plane containing the edge portion 422, and ranges from 2 degrees to 10 degrees. Preferably, the seal film 43 has a smooth inner surface facing the bread ingredient space 41 when the seal film 43 seals the bread ingredient and the container 42.

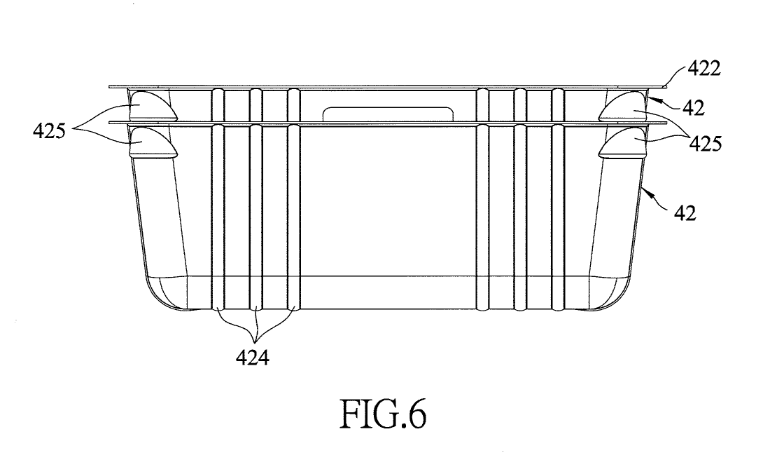

Referring to FIG. 6, in order to conveniently stack a plurality of the empty containers 42 for saving storage space, the reinforcement ribs 424 are capable of enhancing the structural strength between the plate portion 421 and the surrounding wall 423, and the reinforcement parts 425 respectively reinforce the corners of the surrounding wall 423, such that the container 42 has sufficient structural strength to support other containers 42. When the containers 42 are required to be separated from each other, the reinforcement parts 425 can avoid the edge portions 422 of the containers 42 from being in tight connection with each other, thereby facilitating the containers 42 to separate from each other.

Referring back to FIGS. 1 and 2, the electrical resistance tag 44 is attached to the plate portion 421, and has an electrical resistance value that is associated with information of the bread ingredients stored in the container 42. Preferably, the electrical resistance tag 44 is printed on the plate portion 421, and is one of a carbon film resistor and a metal film resistor. When the ingredient storage unit 4 is disposed in the receiving space 10, the electrode unit 3 contacts the electrical resistance tag 44 and provides the electrical resistance value of the electrical resistance tag 44 to the baking mechanism 2, and the baking mechanism 2 is configured to make bread automatically using the bread ingredients stored in the container 42 with a particular bread-making process that is determined according to the electrical resistance value received from the electrode unit 3. In detail, in response to receipt of the electrical resistance value from the electrode unit 3, the baking mechanism 2 is configured to determine whether the electrical resistance value is within a predetermined range. Then, when the electrical resistance value is determined to be within the predetermined range, the baking mechanism 2 is further configured to determine the particular bread-making process by selecting, from a plurality of preset bread-making processes preset in the baking mechanism 2, one preset baking process that is associated with the predetermined range. In other words, when the lid body 12 covers the opening 101 of the receiving space 10, the electrode rods 32 directly abut against the electrical resistance tag 44 so as to provide the electrical resistance value of the electrical resistance tag 44 to the baking mechanism 2. When the electrical resistance value is determined to be within the predetermined range, during the particular bread-making process, the controller 27 controls the water supply member 26 to supply a certain amount of water into the baking container 21 at a certain time point, the mixing device 22 to operate for a certain mixing time period, and the heating member 25 to heat the baking container 21 for a certain heating time period.

As shown in FIG. 2, in actual use, the ingredient storage unit 4 is disposed on the supporting frame 23. When the lid body 12 covers the opening 101 of the receiving space 10, the electrode rods 32 directly abut against the electrical resistance tag 44, and the penetrating member 24 pierces the seal film 43. The bread ingredients in the container 42 fall into the baking container 21.

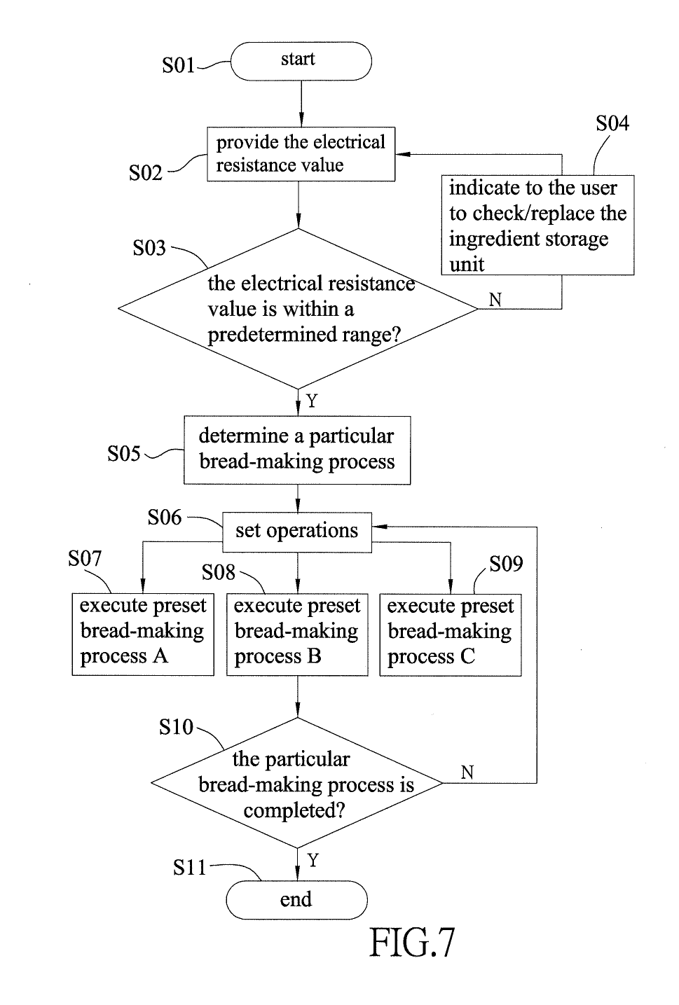

FIG. 7 illustrates a flow chart of a method for making bread implemented by the automatic bread maker assembly according to the preferred embodiment.

In step s01, when the ingredient storage unit 4 is disposed in the receiving space 10 and the lid body 12 covers the receiving space 10 of the automatic bread maker, the automatic bread maker is activated.

In step s02, the electrode rods 32 provides the electrical resistance value of the electrical resistance tag 44 to the controller 27 of the baking mechanism 2.

In step s03, in response to receipt of the electrical resistance value from the electrode unit 3, the controller 27 of the baking mechanism 2 is configured to determine whether the electrical resistance value is within the predetermined range. For example, the predetermined range includes a first range of 1Ω to 50Ω, a second range of 100Ω to 150Ω, and a third range of 200Ω to 250Ω.

When the baking mechanism 2 determines that the electrical resistance value is not within the predetermined range, the automatic bread maker indicates, in step s04, to a user to check or replace the container 42. Then, the flow goes back to step s02.

When the electrical resistance value is determined to be within the predetermined range, the controller 27 of the baking mechanism 2 determines, in step s05, the particular bread-making process by selecting, from the preset bread-making processes A, B and C. For example, the preset bread-making process A refers to the first range of 1˜50Ω, the preset bread-making process B refers to the second range of 100˜150Ω, and the preset bread-making process C refers to the third range of 200˜250Ω. Each of the preset bread-making processes A, B and C corresponds to a certain amount of water supply, a mixing time period, a certain fermenting time period, and a certain heating time period with a certain baking temperature.

In step s06, the controller 27 sets operations of the mixing device 22, the heating member 25 and the water supply member 26 according to the particular bread-making process selected in step s05.

When the preset bread-making process A is selected as the particular bread-making process, step s07 is executed to make bread. In this preferred embodiment, the preset bread-making process A can make a loaf of raisin toast weighing about 275 grams. The bread ingredients include salt, sugar, raisins, oil, yeast and flour. In the preset bread-making process A, the water supply member 26 is controlled to supply 180 grams of water, the mixing device 22 is controlled to mix the bread ingredients in the baking container 21 for 32 minutes, the fermenting time is controlled for 40 minutes, the heating member 25 is controlled to heat for 53 minutes, and the baking temperature is controlled at 170 Celsius degrees.

When the preset bread-making process B is selected as the particular bread-making process, step s08 is executed to make bread. In this preferred embodiment, the preset bread-making process B can make a loaf of French toast weighing about 280 grams. The bread ingredients include salt, sugar, oil, yeast and flour. In the preset bread-making process B, the water supply member 26 is controlled to supply 220 grams of water, the mixing device 22 is controlled to mix the bread ingredients in the baking container 21 for 32 minutes, the fermenting time is controlled for 40 minutes, the heating member 25 is controlled to heat for 53 minutes, and the baking temperature is controlled at 180 Celsius degrees.

When the preset bread-making process C is selected as the particular bread-making process, step s09 is executed to make bread. In this preferred embodiment, the preset bread-making process C can make a loaf of walnut bread weighing about 280 grams. The bread ingredients include salt, sugar, walnuts, oil, yeast and flour. In the preset bread-making process C, the water supply member 26 is controlled to supply 192 grams of water, the mixing device 22 is controlled to mix the bread ingredients in the baking container 21 for 32 minutes, the fermenting time is controlled for 40 minutes, the heating member 25 is controlled to heat for 53 minutes, and the baking temperature is controlled at 175 Celsius degrees.

In step s10, the baking mechanism 2 determines whether the particular bread-making process is completed. If the particular bread-making process is determined as not yet completed, the flow goes back to step s06.

When the particular bread-making process is determined to be completed, the automatic bread maker notifies, in step s11, the user that the bread-making process is completed and the bread is done.

To sum up, by virtue of the electrical resistance tag 44 printed on the plate portion 421, the electrode rods 32 can directly abut against the electrical resistance tag 44. Since the container 42 has the fixed shape, the electrode rods 32 can be used accurately read the resistance value of the resistance tag 44, such that the baking mechanism 2 can be configured to determine the particular baking process to make bread automatically using the bread ingredients in the container 42. In addition, the electrical resistance tag 44 can be a carbon film resistor to reduce the fabrication cost.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An automatic bread maker assembly comprising:
an automatic bread maker including
a casing having a receiving space,
a baking mechanism disposed in said receiving space, and
an electrode unit mounted on said casing and electrically coupled to said baking mechanism; and
an ingredient storage unit removably disposed in said receiving space, said ingredient storage unit including
a container having a bread ingredient space for accommodating bread ingredients, and
an electrical resistance tag attached to said container, and having an electrical resistance value that is associated with information of the bread ingredients stored in said container;
wherein, when said ingredient storage unit is disposed in said receiving space, said electrode unit contacts said electrical resistance tag and provides the electrical resistance value of said electrical resistance tag to said baking mechanism, and said baking mechanism is configured to make bread automatically using the bread ingredients stored in said container with a particular bread-making process that is determined according to the electrical resistance value received from said electrode unit.

2. The automatic bread maker assembly as claimed in claim 1, wherein, in response to receipt of the electrical resistance value from said electrode unit, said baking mechanism is configured to:
determine whether the electrical resistance value is within a predetermined range; and
when the electrical resistance value is determined to be within the predetermined range, determine the particular bread-making process by selecting, from a plurality of preset bread-making processes preset in said baking mechanism, one preset bread-making process that is associated with the predetermined range.

3. The automatic bread maker assembly as claimed in claim 1, wherein said electrical resistance tag is one of a carbon film resistor and a metal film resistor.

4. The automatic bread maker assembly as claimed in claim 1, wherein said electrode unit includes two electrode rods that are disposed on said casing and that are spaced apart from each other.

5. The automatic bread maker assembly as claimed in claim 4, wherein said casing includes a casing body defining said receiving space with an opening, and a lid body movably connected to said casing body for removably covering said opening of said receiving space, said electrode rods being mounted to said lid body;
wherein, when said lid body covers said opening of said receiving space, said electrode rods directly abut against said electrical resistance tag so as to provide the electrical resistance value of said electrical resistance tag to said baking mechanism.

6. The automatic bread maker assembly as claimed in claim 5, wherein said electrode unit further includes two resilient members that resiliently bias said electrode rods, respectively.

7. The automatic bread maker assembly as claimed in claim 1, wherein said container has a fixed shape, and includes a plate portion, and a surrounding wall extending inclinedly and outwardly from said plate portion with respect to said bread ingredient space, said electrical resistance tag being attached to said plate portion;
wherein said ingredient storage unit further includes a seal film that seals said container.

8. The automatic bread maker as claimed in claim 7, wherein said container further includes an edge portion connected to said surrounding wall and opposite to said plate portion, and an angle between said surrounding wall and a normal line perpendicular to an imaginary plane containing said edge portion ranges from 2 degrees to 10 degrees.

9. The automatic bread maker assembly as claimed in claim 8, wherein said container has a shape substantially of a frustum, and further includes a plurality of reinforcement parts depressed respectively from inside of corners of said surrounding wall and proximate to said edge portion and protruding outwardly and respectively from outside of the corners of said surrounding wall.

10. The automatic bread maker assembly as claimed in claim 1, wherein a thickness of said container ranges from 0.8 millimeter to 1.5 millimeters.

11. An ingredient storage unit for storing bread ingredients therein and adapted to be used in an automatic bread maker that is configured to make bread automatically using the bread ingredients and that includes an electrode unit, said ingredient storage unit comprising:
a container having a bread-ingredient space for accommodating the bread ingredients; and
an electrical resistance tag attached to said container, and having an electrical resistance value that is associated with information of the bread ingredients stored in said container;
wherein, when said ingredient storage unit is disposed in the automatic bread maker, said electrical resistance tag contacts the electrode unit so as to allow the electrode unit to provide the electrical resistance value of said electrical resistance tag to the automatic bread maker, thereby enabling the automatic bread maker to make bread using the bread ingredients stored in said container with a particular bread-making process that is determined according to the electrical resistance value provided by the electrode unit.

12. The ingredient storage unit as claimed in claim 11, wherein said electrical resistance tag is selected from one of a carbon film resistor and a metal film resistor.

13. The ingredient storage unit as claimed in claim 11, wherein said container has a fixed shape, and includes a plate portion, and a surrounding wall extending inclinedly and outwardly from said plate portion with respect to said bread ingredient space, said electrical resistance tag being attached to said plate portion;
wherein said ingredient storage unit further includes a seal film that seals said container.

14. The ingredient storage unit as claimed in claim 13, wherein said container further includes an edge portion connected to said surrounding wall and opposite to said plate portion, and an angle between said surrounding wall and a normal line perpendicular to an imaginary plane containing said edge portion ranges from 2 degrees to 10 degrees.

15. The ingredient storage unit as claimed in claim 14, wherein said container has a shape substantially of a frustum, and further includes a plurality of reinforcement elements disposed respectively in corners of said surrounding wall and proximate to said edge portion and extending transversely from said surrounding wall into said bread ingredient space.

16. The ingredient storage unit as claimed in claim 11, wherein a thickness of said packed container ranges from 0.8 millimeter to 1.5 millimeters.

17. An automatic bread maker configured to make bread automatically using bread ingredients stored in an ingredient storage unit, the ingredient storage unit including an electrical resistance tag having an electrical resistance value associated with information of the bread ingredients, said automatic bread maker comprising:
a casing having a receiving space;
a baking mechanism disposed in said receiving space; and
an electrode unit mounted on said casing seat and electrically coupled to said baking mechanism;
wherein, when the ingredient storage unit is disposed in said receiving space, said electrode unit contacts the electrical resistance tag and provides the electrical resistance value of the electrical resistance tag to said baking mechanism, and said baking mechanism is configured to make bread automatically using the bread ingredients with a particular bread-making process that is determined according to the electrical resistance value received from said electrode unit.
